(19) United States
(12) Patent Application Publication
(10) Pub. No.: US 2026/0225887 A1
(43) Pub. Date: Aug. 6, 2026

(54) SULFATE BYPRODUCT CONVERSION

(71) Applicant: FORD GLOBAL TECHNOLOGIES, LLC, Dearborn, MI (US)

(72) Inventors: Wenhui ZHU, Northville, MI (US); Ji Woo KIM, Novi, MI (US); Kevin MASEL, Northville, MI (US)

(21) Appl. No.: 19/042,967

(22) Filed: Jan. 31, 2025

(51) Int. Cl. C01B 25/14; H01M 10/0525; H01M 10/0562; H01M 10/36

(52) U.S. Cl. CPC C01B 25/14; H01M 10/0525; H01M 10/0562; H01M 10/36; C01P 2006/40; H01M 2300/0068

(57) ABSTRACT

A method for producing a sodium-based phosphorus sulfide conductor for use in solid electrolyte materials is presented. The method involves drying a sodium-based sulfate feedstock derived from a water-based solution to eliminate residual moisture, forming a dried sodium-based sulfate feedstock. The dried feedstock is then reacted with a carbon-containing material under specific conditions to convert it into a sodium-based sulfide. The sodium-based sulfide is subsequently reacted with a phosphorus-based sulfide reagent via a mechanical milling process, yielding a sodium-based phosphorus sulfide conductor.

### TECHNICAL FIELD

This disclosure relates to the recycling and reuse of by-products generated during the manufacturing of precursor cathode active materials for lithium-ion and sodium-ion batteries.

### BACKGROUND

The production of precursor cathode active materials for lithium-ion and sodium-ion batteries generates sodium sulfate as a by-product. Developing methods to repurpose sodium sulfate by-product into useable materials presents an opportunity.

### SUMMARY

A method for producing a sodium-based phosphorus sulfide conductor is provided. This method includes drying a sodium-based sulfate feedstock obtained from a water-based solution to remove residual moisture and form dried sodium-based sulfate feedstock, reacting the dried sodium-based sulfate feedstock with a carbon-containing material under conditions that convert the dried sodium-based sulfate feedstock into a sodium-based sulfide, and reacting the sodium-based sulfide with a phosphorus-based sulfide reagent through a mechanical milling process to yield a sodium-based phosphorus sulfide conductor for a solid electrolyte material. The drying may be done between 100 to 120° C. Converting the sodium-based sulfate feedstock into a sodium-based sulfide may be done at a temperature between 800 to 1000° C. The carbon-containing material used for the conversion to a sodium-based sulfide may have a carbon content above 99.5%. The mechanical milling of the sodium-based sulfide with the phosphorus-based sulfide reagent may be performed under an inert atmosphere selected from nitrogen, argon, or another non-reactive gas. The method may include controlling milling time, milling speed, and milling media composition. The method may include a purification step following formation of the sodium-based sulfide. A resulting sodium-based phosphorus sulfide conductor may be subjected to a heat treatment. The sodium-based phosphorus sulfide conductor may have an ionic conductivity greater than 1×10-3 S/cm at 25° C.

A method for producing a conductor is provided. This method includes mechanically milling a sodium-based sulfide and a phosphorus-based sulfide reagent in presence of a halogen into a halogen-doped sodium-based phosphorus sulfide conductor. A halogen-containing material may be introduced prior to or during the mechanical milling process. A proportion of halogen-containing material relative to the phosphorus-based sulfide reagent may be between 0.1 to 1.0. The method may include a post-milling annealing step. The halogen doping may increase ionic conductivity to be greater than 1×10-3 S/cm at 25° C.

A method for fabricating a sodium-based phosphorus sulfide conductor is provided. This method includes vaporizing a sodium-based precursor and a phosphorus sulfide precursor in separate heating zones to form respective vapor phases, combining the vapor phases in a reaction chamber maintained at a controlled temperature and pressure, and condensing the combined vapor phases onto a temperature-controlled substrate to form a sodium-based phosphorus sulfide conductor. The heating zones may be maintained at temperatures between 300 to 400° C. for the sodium-based precursor and 450 to 550° C. for the phosphorus sulfide precursor to ensure complete vaporization while preventing decomposition. The temperature-controlled substrate may be maintained at a temperature between 150 to 250° C. to promote controlled condensation and crystalline growth of the sodium-based phosphorus sulfide conductor. The reaction chamber pressure may be maintained between 1×10-3 to 1×10-2 Torr during the vapor phase combination, and the chamber may be continuously purged with high-purity argon. The method may include a post-deposition annealing step at 200 to 300° C. for 2-4 hours under an inert atmosphere. The substrate may be rotated at between 10 to 30 rpm during condensation and maintained at a distance of between 15 to 25 cm from vapor sources.

### BRIEF DESCRIPTION OF THE DRAWINGS

FIG. 1 is a process flow diagram of a production workflow for precursor cathode active materials; and

FIG. 2 is a flow diagram for producing sodium-based phosphorus sulfide conductors.

### DETAILED DESCRIPTION

Unless expressly stated otherwise, when a claim includes a material or process step (e.g., drying, reacting, milling, etc.), that material or process step is assumed to encompass equivalent materials or steps that achieve the same function. Percentages, temperatures, and ratios are understood as being approximate unless explicitly stated otherwise. When a class of materials is described as suitable or preferred, it implies that mixtures or combinations of those materials are equally suitable or preferred. Descriptions of constituents or process steps refer to their state or configuration at the time of application and do not preclude interactions or changes occurring during the process. Acronyms or abbreviations defined once in the specification apply uniformly throughout the disclosure, including grammatical variations of the defined terms. Unless expressly stated otherwise, all measurements and parameters are determined using techniques standard in the field.

As used in this disclosure, the singular forms “a,” “an,” and “the” include plural referents unless the context explicitly indicates otherwise. For example, reference to “a sodium-based sulfide” includes multiple sodium-based sulfides where appropriate. This disclosure is not limited to the specific embodiments and methods described herein, as variations in components, process conditions, and configurations are anticipated. Terminology used is for descriptive purposes and should not be interpreted as limiting unless explicitly stated otherwise.

The term “comprising” as used in the claims is inclusive and open-ended, encompassing additional elements, materials, or steps beyond those expressly recited. For example, a method “comprising” a drying step does not exclude additional processing steps. The phrase “consisting of” is used to indicate that a method or composition is limited to the elements or steps specifically recited.

Numerical ranges explicitly include all intermediate values. For instance, a temperature range of 800° C. to 1000° C. includes 810° C., 820° C., 830° C., and so forth. Similarly, when a range is specified, alternate limits based on evenly spaced increments within the range are implicitly disclosed. For example, a range of 0.1 to 1.0 includes intermediate values such as 0.2, 0.3, 0.4, and so on.

Unless explicitly stated otherwise, all numerical values and ranges in this document are prefixed by the term “about.” This applies even if “about” is not explicitly stated. For example, when a process is described as occurring at “100 to 120° C.,” it should be understood as “about 100 to about 120° C.,” accounting for variations typical of industrial processes and measurement techniques. Similarly, when a parameter is described as having a specific value, such as “99.5% carbon content,” it should be interpreted as “about 99.5% carbon content.”

The term “sodium-based sulfide” refers to a compound containing sodium and sulfide ions as its primary constituents. The term “phosphorus-based sulfide reagent” refers to a compound containing phosphorus and sulfide ions, used as a reactant in the disclosed methods. These terms include derivatives and equivalents commonly used in the field.

The term “mechanical milling” refers to the process of grinding or blending materials using mechanical means, such as a ball mill or attritor mill, under controlled conditions. The milling atmosphere, speed, time, and media composition are understood as variables that may be adjusted to optimize the reaction.

The term “solid electrolyte material” refers to a material capable of conducting ions, typically used in solid-state battery applications. The disclosed sodium-based phosphorus sulfide conductor is designed for use in such applications and exhibits ionic conductivity suitable for solid-state electrolytes.

The use of a halogen-containing material in the process, as disclosed in certain claims, includes any material containing halogen atoms that increase the properties of the resulting conductor. Similarly, vapor-phase processes are understood to include variations in temperature, pressure, and flow rates that achieve equivalent results.

The transition to electric vehicles and plug-in hybrid electric vehicles requires advancements in lithium-ion batteries, with nickel manganese cobalt (NMC) cathodes being often utilized due to their exceptional energy densities ranging from 570 to 800 mWh/g. These cathodes, known for their high energy storage capacity and reliability, play a reoccurring role in modern battery systems. However, the large-scale production of NMC cathode active materials (CAM) and their precursors (pCAM) generates significant amounts of sodium sulfate as a byproduct. Sodium sulfate is primarily formed during the synthesis of transition metal hydroxides such as nickel hydroxide, cobalt hydroxide, and manganese hydroxide from their corresponding metal sulfate salts.

At present, the disposal of sodium sulfate is managed through methods such seawater dilution or landfill dumping. While these methods may appear straightforward, they pose challenges. Establishment of environmentally sustainable pCAM manufacturing facilities has been an increasingly important challenge.

To address the dual challenges of environmental sustainability and resource utilization, this disclosure proposes a recycling strategy that transforms sodium sulfate, a byproduct of the pCAM process, into a solid-state electrolyte material, such as sodium-based phosphorus sulfide. Sodium-based phosphorus sulfide is a sodium superionic conductor material with high ionic conductivity, reaching values up to 7.4×10⁻⁴ siemen per centimeter (S/cm). This material has emerged as a promising candidate for next-generation sodium-ion batteries, offering a pathway to diversify battery chemistries beyond lithium-based systems.

The recycling process may involve three distinct steps. First, the sodium sulfate is dried to remove residual moisture, ensuring that it is in a stable and reactive state for subsequent chemical transformations. This drying step achieves consistent reaction kinetics and prevents complications arising from residual water during high-temperature reactions.

The second step involves converting the dried sodium sulfate into sodium sulfide through a reduction reaction with a carbonaceous material such as coal or charcoal. This reaction, which mimics aspects of the historical Leblanc process, operates at elevated temperatures to produce sodium sulfide and carbon dioxide as byproducts. The reaction is represented as:

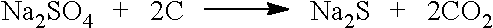

Sodium sulfide, the intermediate product, serves as a precursor for the subsequent synthesis of the sodium-based phosphorus sulfide (Na₃PS₄).

In the third step, sodium sulfide (Na₂S) is reacted with phosphorus pentasulfide (P₂S₅) using a mechanical ball milling process. Ball milling is a high-energy mechanical method that promotes intimate mixing of reactants and facilitates the formation of Na₃PS₄ at relatively low temperatures compared to conventional thermal synthesis. The mechanical milling process not only reduces energy consumption but also ensures uniform particle size distribution, which is critical for achieving optimal ionic conductivity in the final product.

To further increase the performance of Na₃PS₄ as a solid electrolyte, halogen doping is introduced during the ball milling step. Halogens such as chlorine or bromine are incorporated into the material's crystal structure, modifying its ionic pathways and increasing ionic conductivity. Halogen doping also improves the compatibility of Na₃PS₄ with adjacent electrode materials, reducing interfacial resistance and increasing overall battery performance. This modification positions Na₃PS₄ as a superior solid-state electrolyte for sodium-ion battery systems.

Prior approaches focus on converting sodium sulfate into sodium hydroxide, lithium hydroxide, and sulfuric acid through electrochemical salt-splitting processes. While these methods address recycling within the context of battery manufacturing, they do not leverage sodium sulfide for the production of advanced solid electrolyte materials by transforming sodium sulfide into Na₃PS₄.

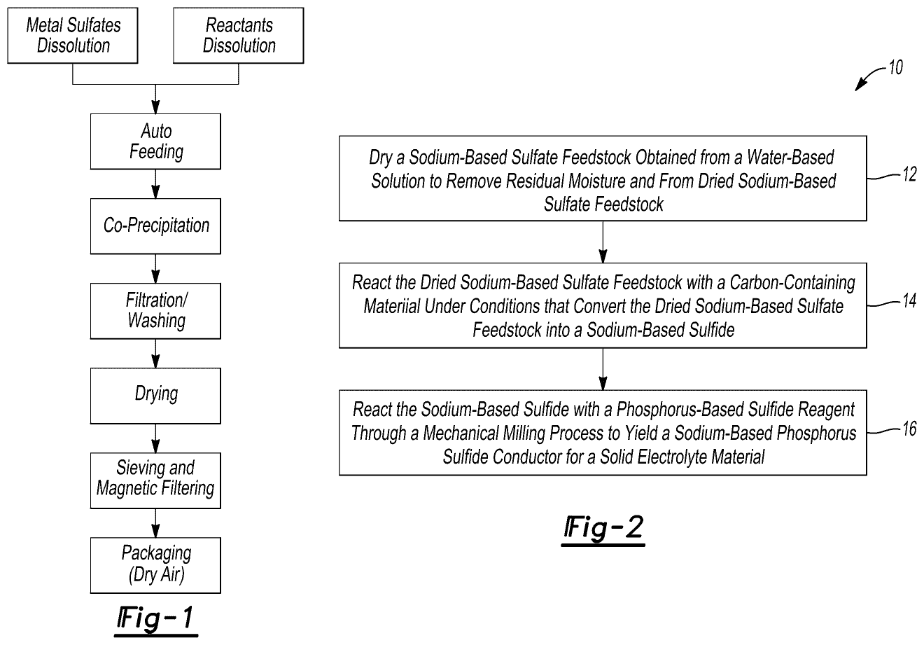

FIG. 1 shows a process for a production workflow, starting from the preparation of raw materials to the final packaging of the pCAM. While this process is effective in producing high-quality materials for cathodes, it simultaneously generates sodium sulfate (Na₂SO₄) as a byproduct.

The process begins with the dissolution of reactants, including sodium hydroxide (NaOH) and ammonium hydroxide (NH₄OH), to prepare an alkaline solution. Simultaneously, metal sulfates such as nickel sulfate (NiSO₄), cobalt sulfate (CoSO₄), and manganese sulfate (MnSO₄) are dissolved in water to create a solution with specific stoichiometric ratios. These ratios determine the composition of the final pCAM, which can be adjusted to achieve different NMC chemistries such as NMC811, NMC622, or NMC523, depending on the desired application.

Once the solutions are prepared, they are fed into a continuously stirred tank reactor (CSTR) through an automated feeding system. The CSTR enables control over the co-precipitation process, where the metal sulfate solution reacts with the alkaline solution to form transition metal hydroxides (TM(OH)₂), such as nickel hydroxide, cobalt hydroxide, and manganese hydroxide. The reaction also produces sodium sulfate as a byproduct, as described by the equation:

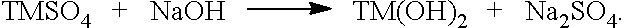

The co-precipitation process determines the particle size, morphology, and chemical composition of the pCAM, all of which directly influence the electrochemical performance of the final cathode materials.

Following co-precipitation, the precipitated TM(OH)₂ is subjected to filtration and washing to remove residual reactants, impurities, and the byproduct Na₂SO₄. This step ensures that the material meets the purity standards required for battery-grade cathode materials. The washed material is then dried to remove any remaining moisture, stabilizing it for further processing.

After drying, the material undergoes sieving and magnetic filtering to eliminate agglomerates and metallic impurities. These steps are essential for achieving uniform particle size distribution and preventing defects that could degrade the performance of the final cathode material. Once these quality control steps are complete, the pCAM is packaged under dry air conditions to maintain its stability and prevent contamination during storage and transportation.

While the process effectively produces high-performance pCAM for NMC cathodes, it generates substantial amounts of Na₂SO₄ as a byproduct. For every mole of TM(OH)₂ produced, an equivalent mole of Na₂SO₄ is formed. The present disclosure offers a solution by recycling Na₂SO₄ into a solid electrolyte material, Na₃PS₄, for sodium-ion batteries.

FIG. 2 is a stepwise process 10 for producing sodium-based phosphorus sulfide conductors, which are used as solid electrolytes in advanced sodium-ion batteries. The method outlines three main steps—drying, reduction, and mechanical milling—that collectively convert sodium sulfate, a common industrial byproduct, into a high-value solid electrolyte material.

The process begins with step 12, the drying of a sodium-based sulfate feedstock obtained from a water-based solution. This drying step is essential to remove residual moisture from the feedstock, as any remaining water could interfere with the efficiency of subsequent chemical reactions. The drying process is performed at a temperature range of 100° C. to 120° C., which is carefully selected to completely eliminate moisture without altering the chemical composition of the feedstock. The result is a stable, moisture-free sodium-based sulfate feedstock, prepared for the next step in the process.

In the second step 14, the dried sodium-based sulfate feedstock is reacted with a carbon-containing material under high-temperature conditions to produce sodium-based sulfide. This reaction is carried out at temperatures between 800° C. and 1000° C. The carbon material used in this reaction has a high purity, typically exceeding 99.5%, which ensures an efficient transformation.

The second step 14 mimics the reduction principles of the Leblanc process, transforming sodium sulfate into sodium sulfide, a crucial intermediate for the final product. Optional purification steps may be included after this reaction to remove any residual impurities, such as unreacted sodium sulfate or carbon, ensuring that the sodium-based sulfide is of sufficient quality for further processing.

In the final step 16, the sodium-based sulfide is reacted with a phosphorus-based sulfide reagent through a high-energy mechanical milling process. This milling is performed under an inert atmosphere, such as nitrogen, argon, or another non-reactive gas, to prevent oxidation or contamination during the reaction. Mechanical milling facilitates intimate mixing and promotes a solid-state reaction between the sodium-based sulfide and the phosphorus-based sulfide reagent, resulting in the formation of a sodium-based phosphorus sulfide conductor.

The mechanical milling process is optimized by controlling parameters, including milling time, speed, and the composition of the milling media. This ensures production of a material with uniform particle size, high purity, and desirable electrochemical properties. To increase the crystallinity and increase ionic transport pathways, the resulting sodium-based phosphorus sulfide conductor may optionally undergo a post-milling heat treatment. The final product exhibits an ionic conductivity greater than 1×10⁻³ S/cm at 25° C., making it a candidate for use in solid-state battery applications.

Although exemplary embodiments are described above, they are not intended to represent all possible forms of the disclosure. The language used in the specification is descriptive rather than limiting, and it is understood that various modifications can be made without departing from the spirit and scope of the disclosure. Furthermore, the features of different embodiments may be combined to create additional embodiments of the disclosure.

What is claimed is:

1. A method for producing a sodium-based phosphorus sulfide conductor comprising:
drying a sodium-based sulfate feedstock obtained from a water-based solution to remove residual moisture and form dried sodium-based sulfate feedstock;
reacting the dried sodium-based sulfate feedstock with a carbon-containing material under conditions that convert the dried sodium-based sulfate feedstock into a sodium-based sulfide; and
reacting the sodium-based sulfide with a phosphorus-based sulfide reagent through a mechanical milling process to yield a sodium-based phosphorus sulfide conductor for a solid electrolyte material.

2. The method of claim 1 wherein the drying is done between 100 to 120° C.

3. The method of claim 1 wherein converting the sodium-based sulfate feedstock into a sodium-based sulfide is done at a temperature between 800 to 1000° C.

4. The method of claim 1 wherein the carbon-containing material has a carbon content above 99.5%.

5. The method of claim 1 wherein the mechanical milling process is performed under an inert atmosphere selected from nitrogen, argon, or another non-reactive gas.

6. The method of claim 1, further comprising controlling milling time, milling speed, and milling media composition.

7. The method of claim 1, further comprising a purification step following formation of the sodium-based sulfide.

8. The method of claim 1 wherein a resulting sodium-based phosphorus sulfide conductor is subjected to a heat treatment.

9. The method of claim 1 wherein the sodium-based phosphorus sulfide conductor has an ionic conductivity greater than 1×10⁻³ S/cm at 25° C.

10. A method for producing a conductor comprising:
mechanically milling a sodium-based sulfide and a phosphorus-based sulfide reagent in presence of a halogen into a halogen-doped sodium-based phosphorus sulfide conductor.

11. The method of claim 10 wherein a halogen-containing material is introduced prior to or during the mechanical milling process.

12. The method of claim 10 wherein a proportion of halogen-containing material relative to the phosphorus-based sulfide reagent is between 0.1 to 1.0.

13. The method of claim 10, further comprising a post-milling annealing step.

14. The method of claim 10 wherein halogen doping increases ionic conductivity to be greater than 1×10⁻³ S/cm at 25° C.

15. A method for fabricating a sodium-based phosphorus sulfide conductor comprising:
vaporizing a sodium-based precursor and a phosphorus sulfide precursor in separate heating zones to form respective vapor phases;
combining the vapor phases in a reaction chamber maintained at a controlled temperature and pressure; and
condensing the combined vapor phases onto a temperature-controlled substrate to form a sodium-based phosphorus sulfide conductor.

16. The method of claim 15 wherein the heating zones are maintained at temperatures between 300 to 400° C. for the sodium-based precursor and 450 to 550° C. for the phosphorus sulfide precursor.

17. The method of claim 15 wherein the temperature-controlled substrate is maintained at a temperature between 150 to 250° C.

18. The method of claim 15 wherein reaction chamber pressure is maintained between 1×10⁻³ to 1×10⁻² Torr during the vapor phase combination, and the reaction chamber is continuously purged with argon.

19. The method of claim 15, further comprising a post-deposition annealing step at 200 to 300° C. for 2-4 hours under an inert atmosphere.

20. The method of claim 15 wherein the substrate is rotated at between 10 to 30 rpm during condensation and maintained at a distance of between 15 to 25 cm from vapor sources.
